(19) United States
(12) Patent Application Publication
(10) Pub. No.: US 2006/0118706 A1
(43) Pub. Date: Jun. 8, 2006

(54) Remote control device, electronic device, display device, and game machine control device

(75) Inventors: Kohji Hisakawa, Nara (JP); Kohji Yoshifusa, Hiroshima (JP); Kazuhiko Matsumura, Nara (JP); Hajime Kashida, Nara (JP); Fumihiko Aoki, Nara (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka-shi (JP)

(21) Appl. No.: 11/285,214

(22) Filed: Nov. 23, 2005

(30) Foreign Application Priority Data
Nov. 30, 2004 (JP) 2004-346759

(51) Int. Cl. G06M 7/00

(52) U.S. Cl. 250/221

(57) ABSTRACT

A remote control device provided with a means for receiving light from a light-emitting element 21 at a light-receiving element 3 and detecting from a signal thereof a movement amount of a mark 16 on a screen 2a of a display device 2 so as to cause movement of the mark such as a pointer on the screen of the display device in response to a movement amount of a light emission point H of the light-emitting element, wherein the light-receiving element is provided with a semiconductor position detection element, and moreover, is configured to be capable of detecting movement of the light emission point in a horizontal direction and a vertical direction, and causes the mark on the screen of the display device to move due to the signal from the light-receiving element.

### BACKGROUND OF THE INVENTION

This application claims priority under 35 U.S.C. § 119(a) on Patent Application No. 2004-346759 filed in Japan on Nov. 30, 2004, the entire contents of which are hereby incorporated by reference.

The present invention relates to a remote control device that enables a user to speedily and intuitively move a mark on a screen of a display device in a distant position using a free movement in space, and particularly relates to remote control devices, electronic devices, display devices, and game machine control devices that simplify operation on a screen that is displayed on a television or other type of display.

Conventionally, cross-shaped pointer keys or ball pointing devices that have been added to remote controllers are available as devices that operate a pointer as a mark on a screen of a display device in a distant position. Furthermore, coordinate input devices equipped with electrostatic pads or a joystick are also generally available. When using these devices to move a pointer to an intended menu item on current television screens, it is necessary to repetitively press movement direction buttons. Although the pointer will move fast if a movement direction button is held down, when the movement distance is large and the button is held down for a long time, the movement of the pointer speeds up acceleratedly such that the location that a user desires to select is passed over and eventually the movement direction buttons must be pushed numerous times again for fine adjustment, and therefore operability is often poor. Also, ball pointers, electrostatic pads, and joysticks are inconvenient for simple one-handed operation and the movement of the pointer is not intuitive.

It is anticipated that in the near future, channel selection, preprogrammed recording and other such operations will become more complex in devices such as digital televisions, set-top boxes, and DVD recorders due to a greater number and variety of channels, more interactive programs, connection to the Internet, etc. There are more than several hundred channels presently available for viewing on cable television and digital terrestrial television, and it appears that this number of channels will further increase. Also, due to the spread of interactive programs that allow audience participation as well as more comprehensive data telecasts, there is an increasing richness of content in television broadcasting, and accompanying this it is anticipated that on-screen operation of televisions by viewers will be increasingly complicated. Conventional cross-shaped pointer keys and ball pointing devices are not suited for carrying out such operations.

Furthermore, on the receiving side of some remote control devices, a semiconductor position detection element (position sensitive detector, hereinafter abbreviated to “PSD”) is used as a light-receiving element (see Japanese Patent No. 3040045, for example). However, devices provided with these PSDs have also failed to solve these problems in terms of enabling smooth and intuitive two-dimensional movement of a pointer.

### SUMMARY OF THE INVENTION

The present invention has been devised in consideration of these issues, and it is an object thereof to enable movement of a mark on a screen of a display device to be operated smoothly and intuitively.

A remote control device according to the present invention is provided with a means for receiving light from a light-emitting element at a light-receiving element and detecting from a signal thereof a movement amount of a mark on a screen of a display device so as to cause movement of the mark such as a pointer on the screen of the display device in response to a movement amount of a light emission point of the light-emitting element, wherein the light-receiving element comprises a semiconductor position detection element and, is configured to be capable of detecting movement of the light emission point in a horizontal direction and a vertical direction, and the mark on the screen of the display device is moved based on the signal from the light-receiving element.

With this configuration, when light from a light-emitting element is incident on a light-receiving element constituted by a semiconductor position detection element, the remote control device according to the present invention produces a charge at the position of incidence proportional to the amount of light. This charge is conveyed as a photocurrent to a resistive layer, divided in inverse portion to the distance to output terminals, and taken out as an output electric current. By obtaining the difference or ratio of the electric currents, the light-reception position of light on the light-receiving elements can be detected. Since the light-receiving elements are capable of detecting movement on two axes, namely a horizontal direction and a vertical direction of the light emission point, two-dimensional movement of the light emission point of the light-receiving elements can be detected, and by moving the light emission point, the mark on the screen can be moved by a predetermined amount in a predetermined direction. In this way, by employing semiconductor position detection elements capable of receiving light in two dimensions for the light-receiving elements, a remote control device according to the present invention enables smooth and intuitive operation of a mark on the screen of a display device.

Furthermore, in the remote control device according to the present invention, it is possible that the light-receiving element is provided on the display device side and the light-emitting element is provided at a claspable optical operation device.

Further still, in the remote control device according to the present invention, it is possible that the movement amount of a mark on a screen of the display device is adjusted in response to a distance between the light-emitting element and the light-receiving element. With this configuration, the mark can be moved on the screen by a predetermined amount corresponding to the movement amount of the light-emitting element regardless of the distance between the light-emitting element and the light-receiving element.

Furthermore, in the remote control device according to the present invention, it is possible that the distance between the light-emitting element and the light-receiving element is measured using a sum of output electric current of the light-receiving element or by adding to a light-receiving side a light-receiving element, which is different from the light-receiving element, and is constituted by a semiconductor position detection element. With this configuration, distance information for adjusting the movement amount of the mark can be obtained based on information of the distance between the light emission point of the light-emitting element and the light-receiving element.

Further again, in the remote control device according to the present invention, it is possible that the light-receiving element is provided on the optical operation device side and the light-emitting element is provided on the display device side, and a relative position of the optical operation device to the display device side is detected at the optical operation device side. With this configuration, an optical signal is transmitted to the optical operation device side from the display device side to detect a relative positional relationship between the display device side and the optical operation device. This positional information is transmitted from the optical operation device to the display device side and the mark on the screen is moved in response to the positional information.

Moreover, in the remote control device according to the present invention, it is preferable that a mode changing means is provided at the optical operation device for sending a command that causes a mark to move, and a mark movement signal is transmitted only when the mode changing means is being operated, and an ordinary remote controller code signal is transmitted during ordinary operation of a remote controller, and the mark movement signal is a signal that is faster than an ordinary remote controller code signal. Although even existing remote controllers are sufficient in terms of speed of response for ordinary remote controller operations such as selecting channels and adjusting the audio volume, ordinary remote controller codes cannot achieve a direct sense of operation for movement of the mark. For this reason, when moving the mark in a remote control device according to the present invention, the mode changing means is operated and simultaneous to this a signal of a faster modulation than the ordinary remote controller codes is sent. By doing this, transmission times such as that for ordinary remote controller codes can be made unnecessary, and movements of the optical operation device can be reflected directly on the movement of the mark.

Further still, with a remote control device according to the present invention, a mark movement signal is transmitted from the display device side only when the mode changing means by which the mark is moved is being operated. In this case, the mode changing means is operated to transmit an output command of a position detection signal to the display device side, and the display device side outputs the position detection signal due to this signal, with this signal being received at the light-receiving element installed in the optical operation device. Accordingly, it is unnecessary for the position detection signal to be constantly being outputted and it is sufficient for the position detection signal to be outputted only while the mode changing means is being operated.

Furthermore, it is preferable that power is supplied to the light-receiving element and a position detection function is turned on only during a time from when the mode changing means by which the mark is moved is operated until a final position signal is received. In this case, it is unnecessary for the light-receiving element to be constantly in an operating state, and power may be supplied to the light-receiving element and the position detection function is turned on only during the time from when the mode changing means is operated until the final position signal is received.

In the remote control device according to the present invention, it is possible that a light emission intensity of the light-emitting element is adjusted in response to the distance between the light-emitting element and the light-receiving element. Only ordinary dry batteries are incorporated as a power source in the optical operation device provided with the light-emitting element. Ordinarily transmission is carried out with a light emission intensity capable of achieving transmission for the maximum rated distance, and therefore the light emission amount is too strong for the distance at which it is ordinarily used, thus the batteries are used wastefully. By optimizing the electric current that flows to the light-emitting element of the device in response to the distances, the amount of light emitted can be adjusted and battery life can be extended. With this configuration in a remote control device according to the present invention, the distance is detected by the optical operation device, and therefore the amount of light emitted can be regulated based on this information to enable battery life to be extended.

In the remote control device according to the present invention, it is preferable that a means for enlarging a range of angles of light receivable at the light-receiving element is provided in front of the light-receiving element. With this configuration, movement of the point of emission can be detected using a light-receiving element even when the light has a large angle of incidence, and therefore the range of points of emission in which the light-receiving element can operate becomes wider.

Further still, in the remote control device according to the present invention, it is possible that movement distance information obtained by measuring the distance between the light-emitting element and the light-receiving element is reflected on depth-wise direction movement of a mark on a screen. It is conceivable that display devices such as televisions capable of three-dimensional stereoscopic display will be achieved in the future. Conventional flat surface pointing operations will be insufficient in such cases and depth-wise direction operation will also become necessary. In regard to these circumstances, a remote control device according to the present invention will become capable of three-dimensional pointing by reflecting an amount of change in the distance on depth-wise direction movement of the pointer on the screen.

In an electronic device according to the present invention, output of a light-receiving element may be used to detect ordinary remote controller codes. In this case, it is possible to receive both the mark movement signal and the ordinary remote controller code signals using a single light-receiving element. Furthermore, not only in devices such as digital televisions, set-top boxes, and DVD recorders, but also when operating the pointer on a screen displayed on a liquid crystal projector using a personal computer for example, by arranging the light-receiving device provided with a light-receiving element near to the screen and connecting this to the personal computer, it becomes possible to achieve on-screen operation of the projector from a distant location.

The present invention may be a game machine control device that uses the present electronic device. In recent years, flat panel televisions using liquid crystal or plasma displays are continuing to become more mainstream than CRTs. In conventional game machine controllers, points of light emission of a scanning line in a CRT are detected for example, and control is carried out based on its position information on the screen. Along with decreased use of CRTs in televisions, it is conceivable that such systems will be unable to be used in future. For this reason, by using a controller of a system of the present invention, it is possible to send controller information to the screen regardless of the presence or absence of scanning lines, and therefore such a controller is suitable as a controller for future game machines.

### BRIEF DESCRIPTION OF THE DRAWINGS

FIG. 1 is a perspective view showing a remote control device according to an embodiment of the present invention.

FIG. 2a is front view of a rectangular, two-dimensional PSD and FIG. 2b shows a configuration in which two band-shaped PSDs are arranged perpendicular to each other.

FIG. 3 is a block diagram showing light-receiving devices according to an embodiment of the present invention.

FIG. 4 is a cross-sectional view showing a structure and an operational principle of a PSD.

FIG. 5 is a schematic diagram showing how a position of an optical operation device is detected using a PSD to move a pointer on the screen.

FIG. 6a is a front view showing a state in which a movement distance of the pointer on the screen changes regarding when the distance between the optical operation device and the screen is small. FIG. 6b is a front view showing a state in which a movement distance of the pointer on the screen changes regarding when the distance between the optical operation device and the screen is large.

FIG. 7 is a block diagram showing light-receiving devices according to another embodiment of the present invention.

FIG. 8 is a top view showing a principle by which a distance between a light emission point of the optical operation device and the screen is detected by adding a PSD.

FIG. 9 is a perspective view that shows a remote control device according to another embodiment of the present invention when the PSD is installed on the optical operation device side and the light-emitting element is provided on the display device side.

FIG. 10 is a top view showing how the range of receivable light of the PSD is expanded by using a plurality of slits.

FIG. 11 is a perspective view in which remote control of a screen is achieved using a projector.

FIG. 12 is an outline perspective view showing how the pointer is moved three-dimensionally on a screen.

### DESCRIPTION OF THE PREFERRED EMBODIMENTS

Hereinafter, embodiments of the present invention will be described with reference to the accompanying drawings.

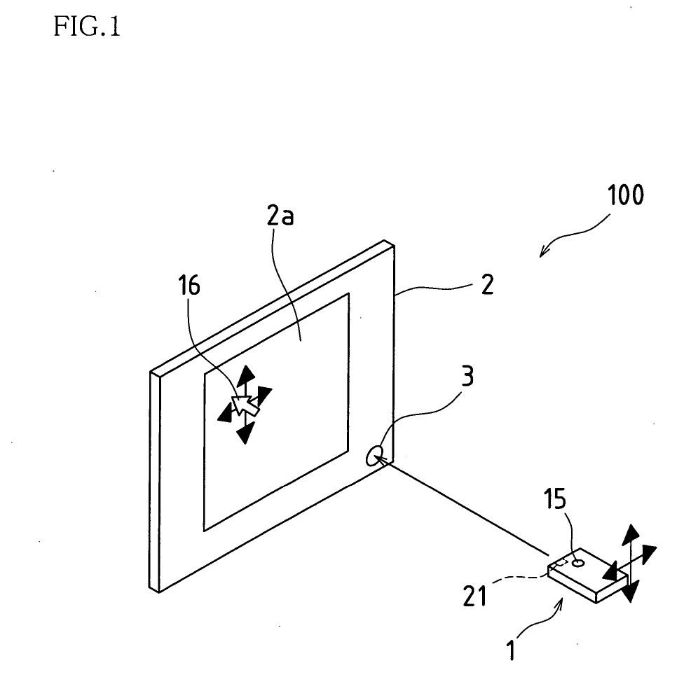

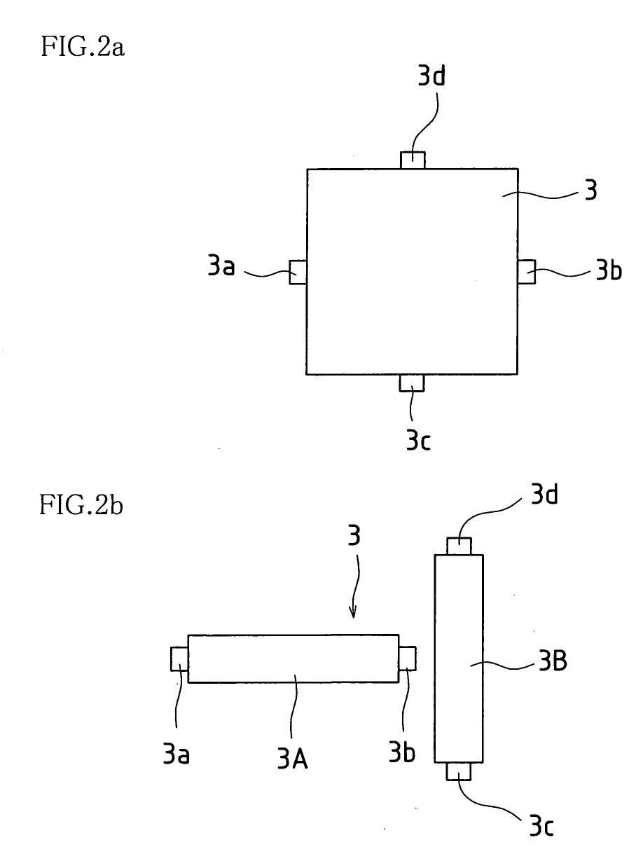

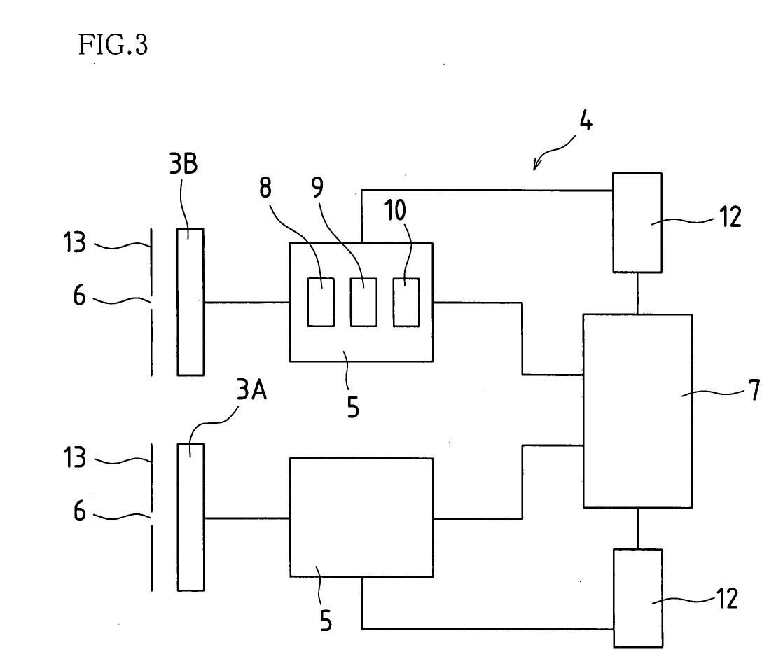

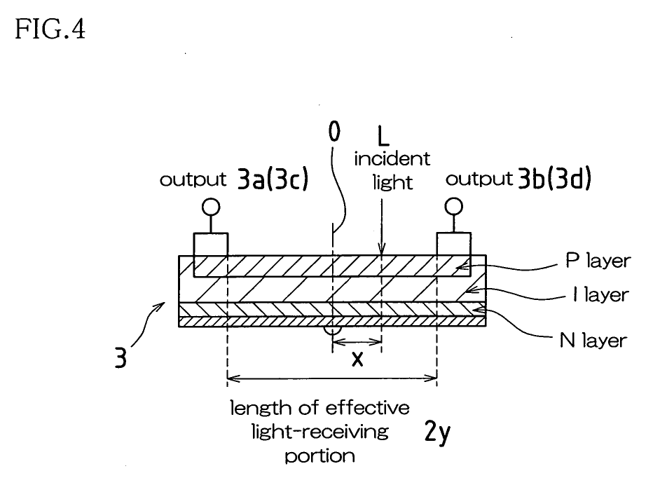

FIG. 1 is a perspective view showing an outline of a remote control device according to an embodiment of the present invention. FIG. 2 is a front view showing an arrangement of light-receiving elements. FIG. 3 is a block diagram of a light-receiving device side. FIG. 4 is a cross-sectional view showing a PSD detection principle.

The remote control device 100 shown in FIG. 1 is provided with a pointing device 1 as an optical operation device provided with a light-emitting element 21 that emits infrared light for example, a display device 2 having a screen 2a, and a PSD 3 as a light-receiving element arranged at the display device 2.

As shown in FIG. 4, the PSD 3 is a component in which a P layer is formed at a surface of a flat plate of silicon, with an N layer at a back face, and an I layer in between. When a spot of light L is incident, an electric charge is produced proportional to the light energy at the position of incidence, such that the produced electric charge passes as a photocurrent through a resistive layer (the P layer) and is divided and outputted from electrodes 3a and 3b provided at ends of the PSD 3 as electric currents Ia and Ib.

Since the P layer is configured such that it has an equal resistance value throughout the layer, the electric currents Ia and Ib are divided and outputted as proportions inversely proportional to the distances from the position of incidence to the electrodes 3a and 3b, that is, to the resistance values. Here, when the distance (length of effective light-receiving portion) between the electrodes 3a and 3b is given as 2y and a distance from a center O of the PSD 3 to the position in which the light L is incident is given as x, the following relational expression is established.
(Ib−Ia)/(Ia+Ib)=x/y (1)

Accordingly, by obtaining the difference and sum of the electric currents Ia and Ib, the incidence position x of incident light L can be obtained from expression (1).

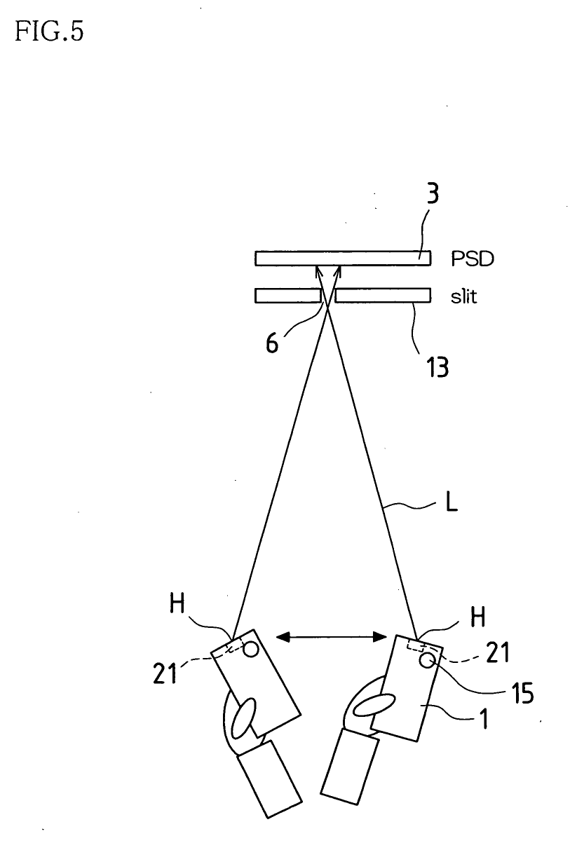

As shown in FIG. 5, a screening wall 13 having a slit 6 is provided in front of the PSD 3. By provided the screening wall 13 in front of the PSD 3, the light L that passes through the slit 6 becomes a spot whose direction is defined. When a light emission point H of a light-emitting element moves, the light-reception position on the PSD 3 of the light L that has passed through the slit 6 also changes. Accordingly, if the change in the light-reception position on the PSD 3 is detected, then the change in the position of the light emission point H can also be detected. It should be noted that it is also possible to use a lens instead of the screening wall 13 that is provided with the slit 6.

Two-dimensional movement of the light emission point H can be detected by preparing a PSD 3 with two axes of a horizontal direction and a vertical direction of a plane parallel to the screen 2a of the display device 2. If the light emission point H is caused to move such that movements of the light-reception position are reflected on the movements of the pointer 16 as a mark displayed on the screen 2a of the display device 2, then the pointer 16 on the screen 2a can be moved in a desired direction. As shown in FIG. 2a for example, the PSD 3 is a component in which horizontal direction electrodes 3a and 3b and vertical direction electrodes 3c and 3d are arranged on the rectangular two-dimensional PSD 3. Moreover, as shown in FIG. 2b, the PSD 3 is configured such that a band-shaped PSD 3A arranged in a horizontal direction and a band-shaped PSD 3B arranged in a vertical direction are arranged at a right angle.

Next, a working example of a light-receiving device 4 arranged on the display device 2 side is described with reference to the block diagram shown in FIG. 3. For convenience, the PSD 3 in FIG. 3 is shown divided into a PSD 3A and a PSD 3B, but this is inclusive of the single PSD shown in FIG. 2a.

The light-receiving device 4 is provided with the PSDs 3A and 3B, processing circuits 5, and a control device 7. The processing circuits 5 are constituted by electronic devices in which an amplifier 8, a limiter 9, and a band-pass filter 10 are integrated on a semiconductor chip. The light L that passes through the slits 6 of the screening walls 13 to become incident on the respective PSDs 3A and 3B undergoes photoelectric conversion and is divided and output as electric currents Ia, Ib, Ic, and Id from the electrodes 3a, 3b, 3c, and 3d arranged at the ends of the PSDs 3A and 3B. The output electric currents are respectively amplified by the amplifiers 8, undergo waveform shaping at the limiters 9, are outputted by the band-pass filters 10 as control signals of only a predetermined frequency, and the control signals are transmitted to the control device 7.

By performing signal processing at the processing circuits 5 in this way, it is possible to process at the PSDs 3 installed on the display device 2 side both signals, namely the pointer movement signal as well as the ordinary remote controller code signals (for example, in the case of controlling a television receiver, this includes control signals such as power on/off, volume up/down, and channel change signals).

A movement button 15 is provided as a mode changing means at the pointing device 1. Although even existing remote controllers are sufficient in terms of speed of response for ordinary remote controller operations such as selecting channels and adjusting the audio volume, remote controller codes cannot achieve an intuitive sense of operation for the movement of the pointer 16. For this reason, when moving the pointer 16, the movement button 15 is pushed and simultaneous to this a pointer movement signal is sent from the light-emitting element 21 having a faster modulation than the code signals of the remote controller. By doing this, transmission times such as that for the remote controller codes can be made unnecessary, and movements of the pointing device 1 can be reflected directly on the movement of the pointer 16.

Although even existing remote controllers are sufficient in terms of speed of response for ordinary remote controller operations such as selecting channels and adjusting the audio volume, remote controller codes cannot achieve an intuitive sense of operation for the movement of the pointer. For this reason, when moving the pointer, the movement button 15 is pushed and simultaneous to this a signal of a faster modulation than the remote controller codes is sent. By doing this, transmission times such as that for the remote controller codes can be made unnecessary, and movements of the pointing device 1 can be reflected directly on the movement of the pointer.

Furthermore, the light-receiving device 4 is provided with a distance detection means 12 that detects a distance between the display device 2 side and the pointing device 1 side (between the light-emitting element and the light-receiving element). Specifically, since the slit 6 of the screening wall 13 arranged in front of the PSD 3 defines the direction of the incident light L, when the light emission point H moves, the light-reception position on the PSD 3 of light that has passed through the slit also moves (see FIG. 5). Accordingly, if the change in the light-reception position on the PSD 3 is detected, then the change in the position of the light emission point H can also be detected. Movement of the light emission point H is detected by the PSD 3, and there is a similarity relationship between a triangle formed by the movement range of the light emission point H and the position of the slit and a triangle made by the light-reception range on the PSD 3 and the position of the slit.

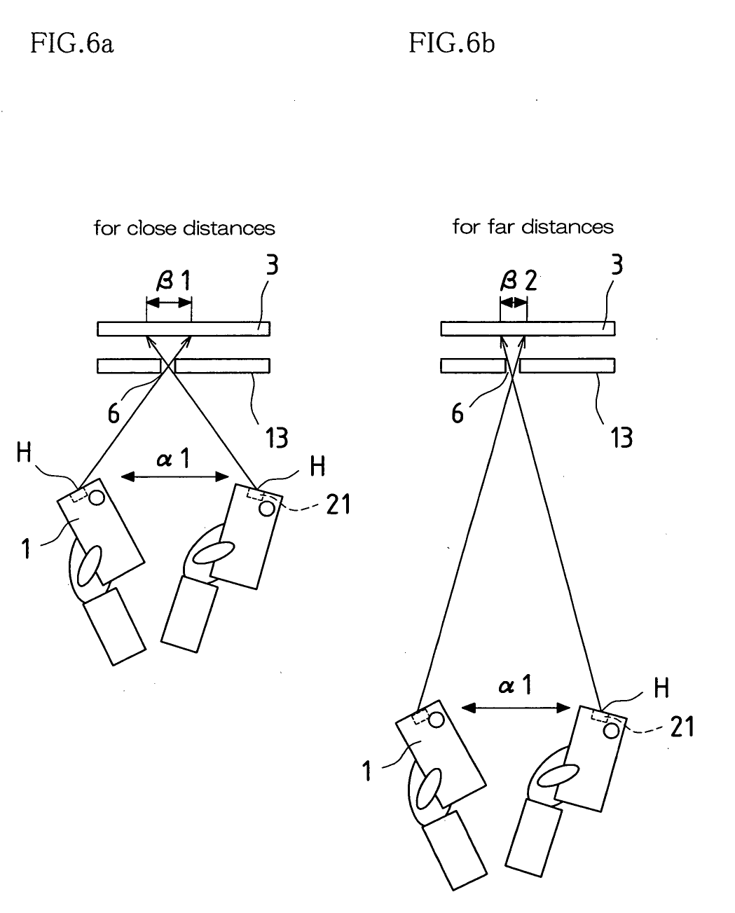

Accordingly, given equivalent movement amounts a of the light emission point H, when the light emission point H and the position of the slit 6 (=screen position) are close, then a movement range β1 of the light-reception position on the PSD 3 becomes larger (see FIG. 6a), and conversely, when the light emission point H and the position of the slit 6 are distant, a movement range β2 of the light-reception position on the PSD 3 becomes smaller (see FIG. 6b). Ordinarily, the pointer 16 on the screen would be moved by an amount proportional to the movement amount of the light-reception position on the PSD 3, and therefore if this circumstance remains unchanged, the movement amounts of the light emission point H required for moving the pointer 16 on the screen 2a by the same distance would end up varying for different distances between the screen 2a and the light emission point H. Moreover, even when the movement amounts of the light emission point H were the same, the movement amount of the pointer 16 would end up being different due to the distances to the screen 2a.

Such a behavior can in no way be said to be providing good usability. To solve this issue, it is necessary to detect the distance between the PSD 3 (screen 2a) and the light emission point H, then correct and adjust the pointer movement amount based on that distance. For example, when the moveable distance of the light emission point H with respect to the PSD 3 is 0.5 m to 5 m, the resolution of the PSD 3 when the distance is 5 m is the minimum resolution, which is 1/10th of the resolution of the PSD 3 when the distance is 0.5 m. Accordingly, when the distance is 0.5 m, the pointer 16 can move by a single unit when the light-reception position moves ten times the minimum resolution on the PSD.

As described above, the output of the PSD 3 is electric currents flowing into two electrodes, and in general, in order to detect the movement amount of the light emission point H at the PSD 3, the difference between the output electric currents is subtracted from the sum of the output electric currents such that there is no dependence on the total amount of received light. In the present embodiment, the distance detection means 12 is provided to detect the distance between the light emission point H and the PSD 3 using the fact that the sum of the output electric current becomes small when the distance between the PSD 3 and the light emission point H is far and the sum of the output electric current becomes large when the distance is close. The distance detection means 12 detects the distance based on a sum value of the output electric current. The distance information thereof is transmitted to the control device 7 and based on the distance information that has been transmitted, the control device 7 adjusts and corrects the movement amount so that the pointer 16 moves by a predetermined amount corresponding to the movement amount of the light emission point H regardless of the distance between the light emission point H and the screen 2a (even when the pointing device 1 is arbitrarily distant from the display device 2).

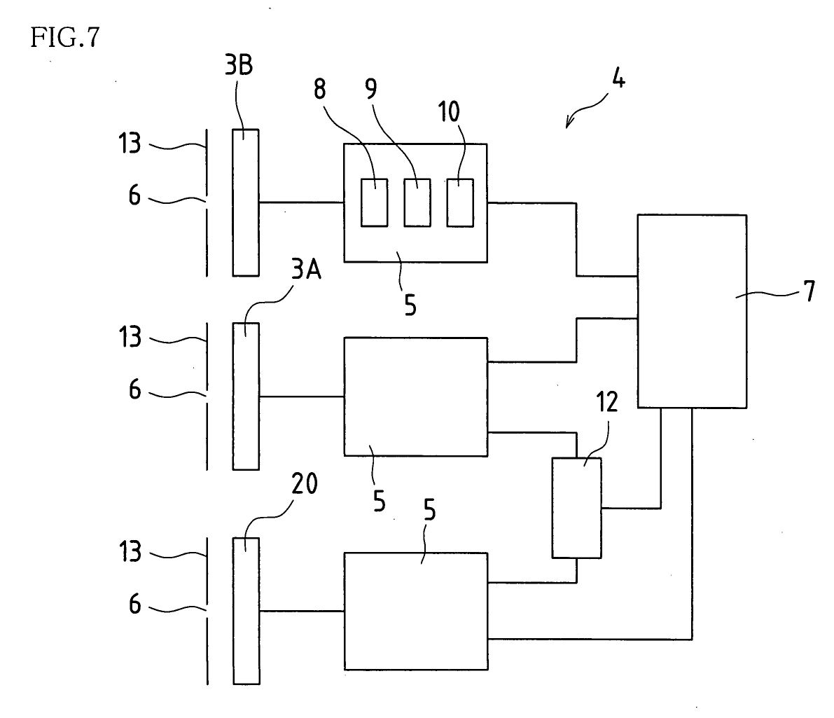

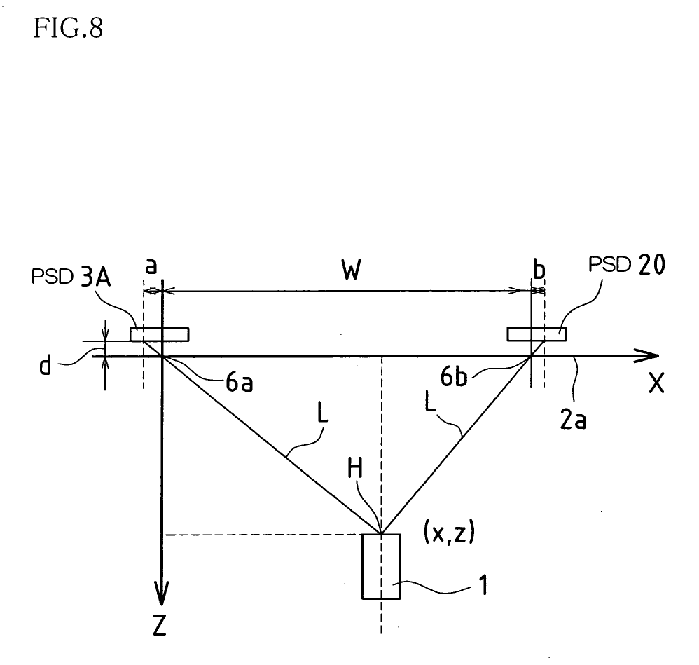

FIGS. 7 and 8 show a different embodiment of the light-receiving device 4. It should be noted that members identical to the foregoing embodiment are given identical symbols and description thereof is omitted. In the present embodiment, another PSD 20 is employed to measure the distance between the light emission point H and the screen 2a. The distance between the light emission point H and the screen 2a can be detected by using the added PSD 20 and one of the aforementioned PSDs 3 (the horizontal direction PSD 3A for example) as shown in FIG. 8.

Regarding the PSD 3A,
a:d=x:z
az=dx (2)
It should be noted that the slits 6a and 6b and the screen 2a are set on the same surface. Furthermore, “a” is a distance from the slit 6a to the light-reception position of the PSD 3A. And “d” is a distance from the slits 6a and 6b to the PSDs 3A and 20.

Regarding the PSD 20,
b:d=(W−x):z
bz=(W−x)d (3)
It should be noted that “b” is a distance from the slit 6b to the light-reception position of the PSD 20. And “W” is a distance between the slits 6a and 6b. From expressions (2) and (3),
x=aW/(a+b), z=dW/(a+b) (4)
If “a” and “b” are known, a distance z between the light emission point H and the screen 2a can be determined using expression (4), and distance information for adjusting the pointer movement amount can be obtained. Based on information of both the PSD 3A and the PSD 20, the distance detection means 12 carries out the above-described calculation and transmits the information thereof to the control device 7.

Furthermore, as described above, since the distance between the screen 2a and the light emission point H can be detected in the present embodiment, the amount of light emitted by the light-emitting element 21 is regulated based on that information such that battery life can be extended. Specifically, only ordinary dry batteries are incorporated as a power source in the pointing device 1. Ordinarily configurations are such that transmission is carried out with a light emission intensity capable of achieving transmission for the maximum rated distance, and since the light emission amount is too strong for the distance at which it is ordinarily used, it is a fact that currently batteries are used wastefully. By providing in the light-receiving device 4 a transmission means that transmits information to the pointing device 1 side corresponding to the distance between the screen 2a and the light emission point H, and having the transmission means transmit information to a receiving means provided in the pointing device 1 side, the electric current that flows to the light-emitting element can be optimized to enable adjustment of the amount of light emission, thus enabling dry battery life to be extended.

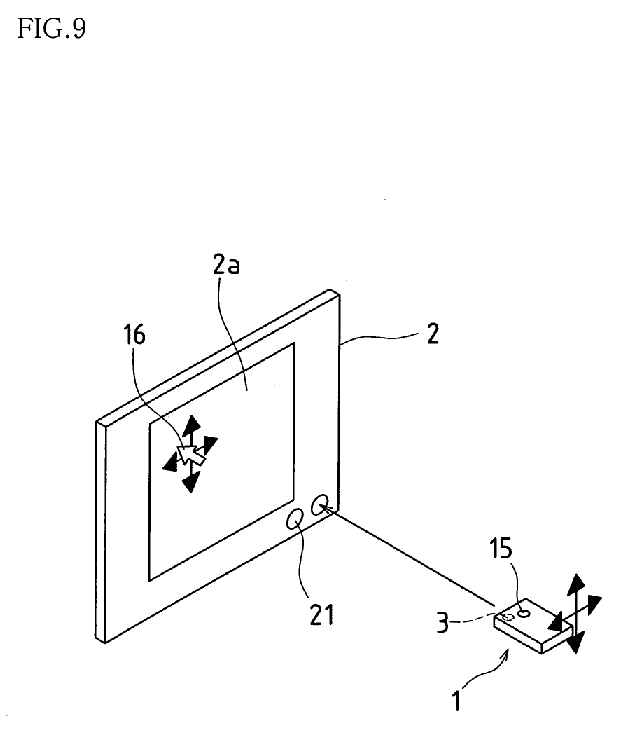

Another embodiment shown in FIG. 9 is a configuration in which the PSD 3 is provided on the pointing device 1 side and the light-emitting element 21 is provided on the display device 2 side, such that the relative position of the pointing device 1 to the display device 2 side is detected at the pointing device 1. Furthermore, this is arranged such that the pointer movement signals from the display device 2 side is transmitted only when the movement button 15 provided in the pointing device 1 is being pressed.

First, the movement button 15 of the pointing device 1 is pressed to transmit an output command of a position detection signal to the display device 2 side, and the display device 2 outputs the position detection signal due to this signal, with this signal being received at the PSD 3 provided in the pointing device 1. Accordingly, it is unnecessary for the position detection signal of the display device 2 side to be constantly being outputted and it is sufficient for the position detection signal to be outputted only while the movement button 15 is being pushed.

Furthermore, power is supplied to the PSD 3 and the position detection function is turned on only during the time from when the movement button 15 is pushed until the final position signal is received. Accordingly, it is unnecessary for the PSD 3 to be constantly in an operating state, and power is supplied to the PSD 3 and the position detection function is turned on only during the time from when the movement button 15 is pushed until the final position signal is received.

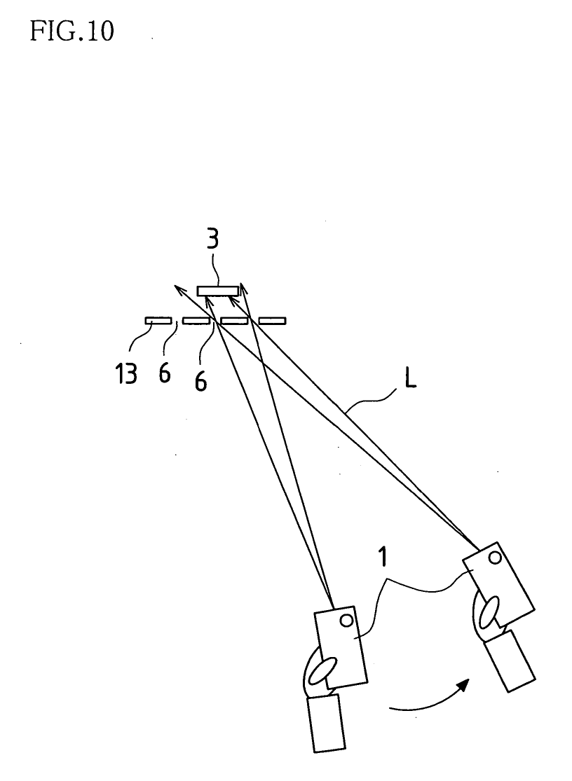

As shown in FIG. 10, in the present embodiment, a screening wall 13 having a plurality of slits 6, 6 . . . in front of the PSD 3 can be provided as a means for enlarging the range of angles of light receivable at the light-receiving element. If there are large deviations in the positions of the light emission point H when there is one slit 6, then the light L that passes through the slit 6 is received at locations other than the PSD 3. Since the light signal cannot be detected when the light L is received at locations other than the PSD, the pointer 16 becomes unable to be moved. For this reason, a plurality of slits 6, 6 . . . are arranged such that light is received on the PSD from only a single slit 6. By doing this, movement of the point of emission can be detected using the PSD 3 even when the light L has a large angle of incidence, and therefore the range of points of emission in which the PSD 3 can operate becomes wider. It should be noted that in the present embodiment the screening wall 13 having slits 6, 6 . . . was shown as an example of a means for enlarging the range of angles of receivable light at the light-receiving element, but it is also possible to use a lens instead of the screening wall 13.

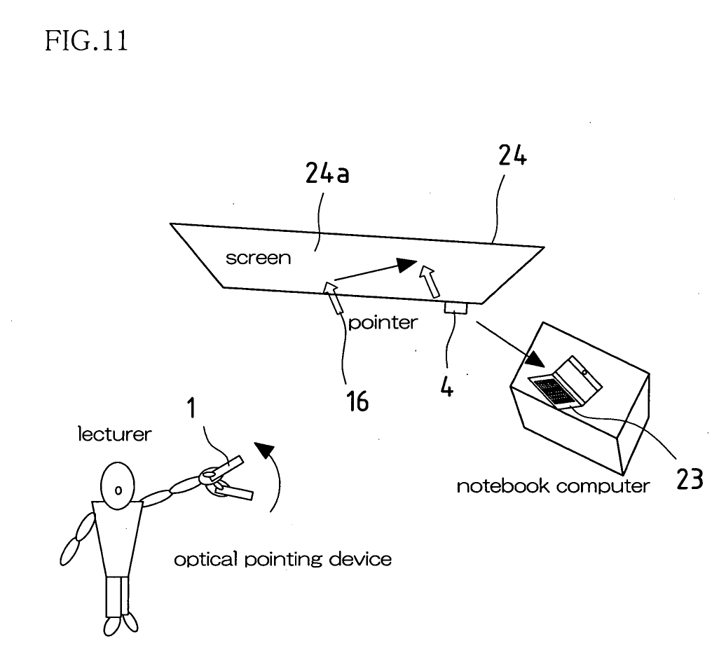

Furthermore, not only in devices such as digital televisions, set-top boxes, and DVD recorders, but also when operating the pointer 16 on a screen 24a displayed on a liquid crystal projector 24 using a personal computer 23 as shown in FIG. 11 for example, by arranging the light-receiving device 4 provided with a PSD near to the screen and connecting this to the personal computer 23, it becomes possible to achieve on-screen operation of the projector 24 from a distant location.

In recent years, flat panel televisions using liquid crystal or plasma displays are continuing to become more mainstream than CRTs. In conventional game machine controllers, points of light emission of a scanning line in a CRT are detected for example, and control is carried out based on its position information on the screen. Along with decreased use of CRTs in televisions, it is conceivable that such systems will be unable to be used in future. For this reason, by using a controller of a system of the present invention, it is possible to send controller information to the screen regardless of the presence or absence of scanning lines, and therefore such a controller is suitable as a controller for future game machines.

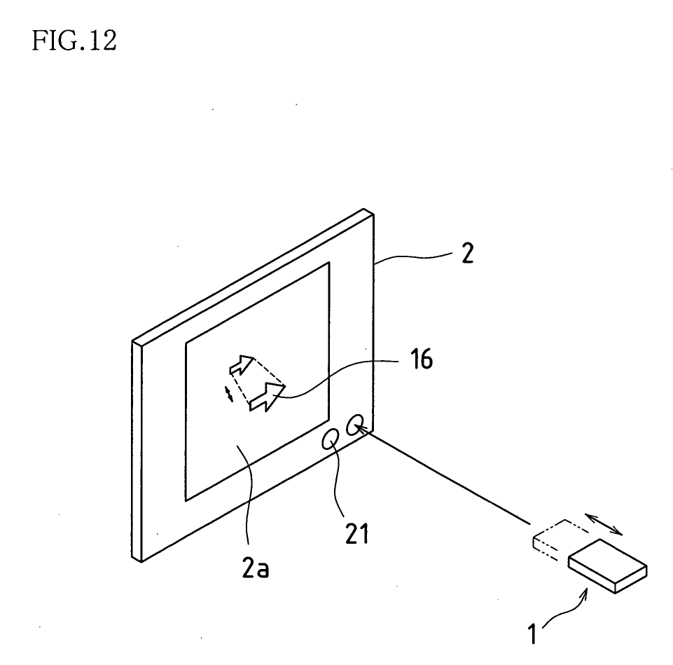

Furthermore, it is conceivable that display devices such as televisions capable of three-dimensional stereoscopic display will be achieved in the future. Conventional flat surface pointing operations will be insufficient in such cases and depth-wise direction operation will also become necessary. Since the distance between the pointing device 1 and the display device 2 can be detected as described in the aforementioned embodiments, three-dimensional pointing is possible by reflecting the amount of change in this distance on movement of the pointer 16 in the depth-wise direction of the screen as shown in FIG. 12.

The present invention can be embodied and practiced in other different forms without departing from the spirit and essential characteristics thereof. Therefore, the above-described embodiments are considered in all respects as illustrative and not restrictive. The scope of the invention is indicated by the appended claims rather than by the foregoing description. All variations and modifications falling within the equivalency range of the appended claims are intended to be embraced therein.

1. A remote control device provided with a means for receiving light from a light-emitting element at a light-receiving element and detecting from a signal thereof a movement amount of a mark on a screen of a display device so as to cause movement of the mark such as a pointer on the screen of the display device in response to a movement amount of a light emission point of the light-emitting element,
wherein the light-receiving element comprises a semiconductor position detection element and, is configured to be capable of detecting movement of the light emission point in a horizontal direction and a vertical direction, and the mark on the screen of the display device is moved based on the signal from the light-receiving element.

2. A remote control device according to claim 1, wherein the light-receiving element is provided on the display device side and the light-emitting element is provided at an optical operation device.

3. A remote control device according to claim 1, wherein the movement amount of a mark on a screen of the display device is adjusted in response to a distance between the light-emitting element and the light-receiving element.

4. A remote control device according to claim 2, wherein the movement amount of a mark on a screen of the display device is adjusted in response to a distance between the light-emitting element and the light-receiving element.

5. A remote control device according to claim 3, wherein the distance between the light-emitting element and the light-receiving element is detected based on a sum of output electric current of the light-receiving element.

6. A remote control device according to claim 4, wherein the distance between the light-emitting element and the light-receiving element is detected based on a sum of output electric current of the light-receiving element.

7. A remote control device according to claim 3, wherein the distance between the light-emitting element and the light-receiving element is measured by adding to a light-receiving side a light-receiving element, which is different from the light-receiving element, and is constituted by a semiconductor position detection element.

8. A remote control device according to claim 4, wherein the distance between the light-emitting element and the light-receiving element is measured by adding to a light-receiving side a light-receiving element, which is different from the light-receiving element, and is constituted by a semiconductor position detection element.

9. A remote control device according to claim 1, wherein the light-receiving element is provided on the optical operation device side and the light-emitting element is provided on the display device side, and a relative position of the optical operation device to the display device side is detected at the optical operation device side.

10. A remote control device according to claim 1, wherein a mode changing means is provided at the optical operation device for sending a command that causes a mark to move, and a mark movement signal is transmitted only when the mode changing means is being operated, and an ordinary remote controller code signal is transmitted during ordinary operation of a remote controller, and the mark movement signal is a signal that is faster than an ordinary remote controller code signal.

11. A remote control device according to claim 9, wherein a mode changing means is provided at the optical operation device for sending a command that causes a mark to move, and a mark movement signal is transmitted from the display device side only when the mode changing means is being operated.

12. A remote control device according to claim 9, wherein a mode changing means is provided at the optical operation device for sending a command that causes a mark to move, and power is supplied to the light-receiving element and a position detection function is turned on only during a time from when the mode changing means is operated until a final position signal is received.

13. A remote control device according to claim 1, wherein a light emission intensity of the light-emitting element is adjusted in response to the distance between the light-emitting element and the light-receiving element.

14. A remote control device according to claim 1, wherein a means for enlarging a range of angles of light receivable at the light-receiving element is provided in front of the light-receiving element.

15. A remote control device according to claim 3, wherein movement distance information obtained by measuring the distance between the light-emitting element and the light-receiving element is reflected on depth-wise direction movement of a mark on a screen.

16. A remote control device according to claim 4, wherein movement distance information obtained by measuring the distance between the light-emitting element and the light-receiving element is reflected on depth-wise direction movement of a mark on a screen.

17. An electronic device capable of being used for the remote control device according to claim 1, comprising a processing means that receives a remote controller code signal and a mark movement signal at a light-receiving element and processes these signals.

18. A display device comprising the electronic device according to claim 17.

19. A game machine control device that uses the electronic device according to claim 17.
